(19) United States
(12) Patent Application Publication
(10) Pub. No.: US 2026/0220362 A1
(43) Pub. Date: Jul. 30, 2026

(54) SYSTEM AND METHOD FOR INTELLIGENT DOCUMENT PROCESSING FOR MULTIMODAL TABLE CORRECTION

(71) Applicant: CANADIAN IMPERIAL BANK OF COMMERCE (CIBC), Toronto (CA)

(72) Inventors: Ozge YELOGLU, Toronto (CA); Kecen YAO, Toronto (CA); Anton SHESTERNEV, Toronto (CA); Ahmad PESARANGHADER, Toronto (CA); Yijun LI, Toronto (CA)

(21) Appl. No.: 19/650,691

(22) Filed: Apr. 17, 2026

Related U.S. Application Data
(60) Provisional application No. 63/944,075, filed on Dec. 18, 2025.

(51) Int. Cl. G06F 40/177; G06F 40/143; G06V 30/412

(52) U.S. Cl. CPC G06F 40/177; G06F 40/143; G06V 30/412

(57) ABSTRACT

A system and method for converting a document image into an extraction-compliant data structure is disclosed. The system and method comprise receiving an image of a page of a document. An intermediate layout data structure that encodes text content and tabular layout information is generated. Errors and inaccuracies in the intermediate layout data structure are repaired using a vision language model and the image as a visual reference to generate a corrected intermediate layout data structure. Information encoded in the corrected intermediate layout data structure may be extracted by queries to a downstream large language model that performs information extraction.

### CROSS-REFERENCE TO RELATED APPLICATIONS

This claims the benefit of, and priority to, U.S. Provisional Patent Application No. 63/944,075, filed on Dec. 18, 2025, the entire contents of which are incorporated herein by reference.

### FIELD

The present disclosure relates to the field of document processing, and in particular to improved systems and methods for automated intelligent document processing (IDP) incorporating artificial intelligence (AI) techniques.

### BACKGROUND

There is a need for reliable, scalable, and interpretable automated processing of documents, and in particular within the banking, insurance, accounting, and financial technology sectors. Many organizations, such as financial institutions, routinely process large volumes of documents, including but not limited to paystubs, invoices, tax statements, credit reports, bank statements, regulatory filings, financial reports, insurance and healthcare billing statements, and utility bills. Often, such documents are obtained in the form of heterogeneous, sometimes low-quality scanned images. These documents often vary widely in layout, typography, and often contain complex elements, including handwritten fields, multi-column tables, and embedded graphics.

The accurate extraction of data from such sources is challenging, yet may be essential for various workflows, including but not limited to credit assessments, compliance auditing, and financial reporting. In practice, many data extraction errors originate from complex table layouts within documents. For example, data extraction errors may be caused by one or more of noisy scans, optical character recognition (OCR) errors, irregular tables (e.g., tables with merged cells), hierarchical headers, column drift, and multi-row labels, mixed narrative and tabular content with an ambiguous reading order, and/or operational requirements for fidelity, auditability, and low change-control overhead.

Because image data and text data belong to different modalities, document-image information extraction is typically handled through a two-stage process. A document may first be converted to an intermediate representation (such as plain text, structural text, or embeddings), and data may then be extracted from the intermediate representation. Some example processes include a) performing an OCR process for text, followed by using an information extractor, b) using a layout model that outputs structural text which is then consumed by a downstream information extractor, or c) using a vision language model (VLM) that encode images into embeddings and then directly decoding answers.

The effectiveness of the above-identified approaches is ultimately limited by the fidelity of the intermediate representation of the multi-modal document. When the intermediate representation is perfectly accurate and faithfully preserves the layout (e.g., borders, merged cells, header positions, and the like) and layout-level context (e.g., table entries), downstream information extraction tends to be more accurate. However, conventional systems and methods frequently introduce layout errors (e.g., misaligned rows, fragmented cells, and/or incorrect table boundaries). Accordingly, there is a need for systems and methods that can analyze and extract information from multi-modal documents with improved reliability and accuracy.

### SUMMARY

In accordance with one aspect, there is provided a computer-implemented method for converting a document to an extraction-compliant data structure, the method comprising: receiving an image of a page of a document; generating, by a layout detection module, an intermediate layout data structure that encodes text content and tabular layout information; repairing, by a table correction module, one or more errors in said intermediate layout data structure based on said image of said page as a visual reference; and generating a corrected intermediate layout data structure representative of contents of said page of said document based on said repairing.

In accordance with another aspect, there is provided a system for converting a document to an extraction-compliant data structure, the system comprising: a computer-readable medium having stored thereon computer-executable instructions that, when executed by one or more processors, cause the one or more processors to perform a method comprising: receiving an image of a page of a document; generating, by a layout detection module, an intermediate layout data structure that encodes text content and tabular layout information; repairing, by a table correction module, one or more errors in said intermediate layout data structure based on said image of said page as a visual reference; and generating a corrected intermediate layout data structure representative of contents of said page of said document based on said repairing.

In accordance with still another aspect, there is provided a computer-readable medium having stored thereon computer-executable instructions that, when executed by one or more processors, cause the one or more processors to perform a method of converting a document to an extraction-compliant data structure, the method comprising: receiving an image of a page of a document; generating, by a layout detection module, an intermediate layout data structure that encodes text content and tabular layout information; repairing, by a table correction module, one or more errors in said intermediate layout data structure based on said image of said page as a visual reference; and generating, a corrected intermediate layout data structure representative of contents of said page of said document based on said repairing.

In some embodiments, said intermediate layout data structure is a hybrid data object wherein the text content of said page is encoded using a first markup language, and the tabular layout information is encoded using a second markup language.

In some embodiments, the first markup language is Markdown, and the second markup language is Hypertext Markup Language (HTML).

In some embodiments, repairing the intermediate layout data structure comprises: receiving, at said table correction module, a training pair comprising a previous intermediate layout data structure and a corrected intermediate layout data structure based on said previous intermediate layout data structure, wherein said repairing is based on said image of said page, said intermediate layout data structure, and said training pair.

In some embodiments, said repairing comprises modifying said HTML code.

In some embodiments, said repairing comprises preserving said Markdown code.

In some embodiments, the table correction module comprises a vision language model, and a temperature parameter of the vision language model is between 0 and 0.8.

In some embodiments, reporting comprises at least one of: detecting misaligned, missing, or erroneously merged cells; splitting merging, and/or re-indexing cell nodes to correct the tabular topology; inserting missing header nodes and/or updating header-to-cell edges; and/or updating span attributes and region borders to reflect corrected geometry.

In some embodiments, repairing comprises receiving, at the table correction module, a prompt comprising an instruction describing a table correction task.

In some embodiments, the method further comprises feed back said corrected intermediate layout data structure to said table correction module; and performing a second iteration of said repairing based on said image of said page and said corrected intermediate layout data structure.

In some embodiments, repairing said intermediate layout data structure comprises a single iteration of said repairing based on said image of said page and said intermediate layout data structure.

Other features will become apparent from the drawings in conjunction with the following description.

### DESCRIPTION OF THE FIGURES

The figures depict example embodiments. It is to be expressly understood that example embodiments described in this disclosure are for the purpose of illustration only, and are not intended to be limiting.

In the figures, which illustrate example embodiments:

FIG. 1 is a block diagram depicting components of an example computing system;

FIG. 2 is a block diagram depicting components of an example computing device;

FIG. 3 depicts a simplified arrangement of software at a computing device;

FIG. 4 depicts a logical arrangement of components of an example document processing and extraction system, in accordance with some embodiments;

FIG. 5 depicts an example of a sample paystub document;

FIG. 6 is an example table correction prompt, in accordance with some embodiments;

FIG. 7 is a table summarizing the paystub data extraction test accuracy across different pipelines for the Paystub Dataset;

FIG. 8 is a table summarizing the results of document-level question answering (QA) using the FinanceQA Dataset;

FIG. 9 is an illustration of an example document image containing tabular data;

FIG. 10A is an illustration of a rendering of a noisy HTML representation of the document of FIG. 9;

FIG. 10B is a rendering of a corrected version based on the noisy HTML representation of FIG. 10A after table correction, in accordance with some embodiments;

FIG. 11 is a table summarizing the improvements in accuracy metrics among various correction techniques;

FIG. 12 is an illustration of an example intermediate layout data structure comprising a hybrid data object generated based on the document depicted in FIG. 5, in accordance with some embodiments; and

FIG. 13 depicts an example corrected intermediate layout data structure comprising a hybrid data object generated by a table correction module, based on the document depicted in FIG. 5 and the noisy intermediate layout representation depicted in FIG. 12, in accordance with some embodiments.

### DETAILED DESCRIPTION

Financial documents such as paystubs, invoices, and financial statements may contain heterogeneous layouts and visually complex tables, which makes reliable information extraction processes challenging using conventional OCR-based pipelines and end-to-end vision language models (VLMs). Some embodiments described herein relate to systems and methods for information extraction from documents using a modular pipeline model. In some embodiments, the pipeline may include (1) a layout detection module configured to convert page images of a document to an intermediate layout data structure (e.g., a hybrid data object, such as a hybrid Markdown-HTML representation); (2) a multimodal table correction module configured to visually ground and repair erroneous data in the the intermediate layout data structure using a VLM; and (3) an information-extraction module that performs schema-driven field extraction and document-level question-answering using the corrected intermediate layout data structure.

Some embodiments described herein may convert document images into a hybrid Markdown-HTML representation and apply a vision-grounded table correction module to rectify layout-level errors in tables and tabular data, which may be effective in improving the accuracy of subsequently extracted information (e.g., an improvement in metrics such as tree edit distance similarity (TEDS) scores). In some embodiments, the corrected representation may be used for schema-based information extraction and/or document-level question answering. Experimental results of some embodiments across paystub field extraction and Finance-QA data sets yield consistent outperformance of OCR-only pipelines and direct VLM baseline metrics.

As such, some embodiments may achieve robust extraction, correction, and reasoning over complex tabular and narrative content in scanned or digital document pages, which can be used to support automation, auditability, and/or compliance.

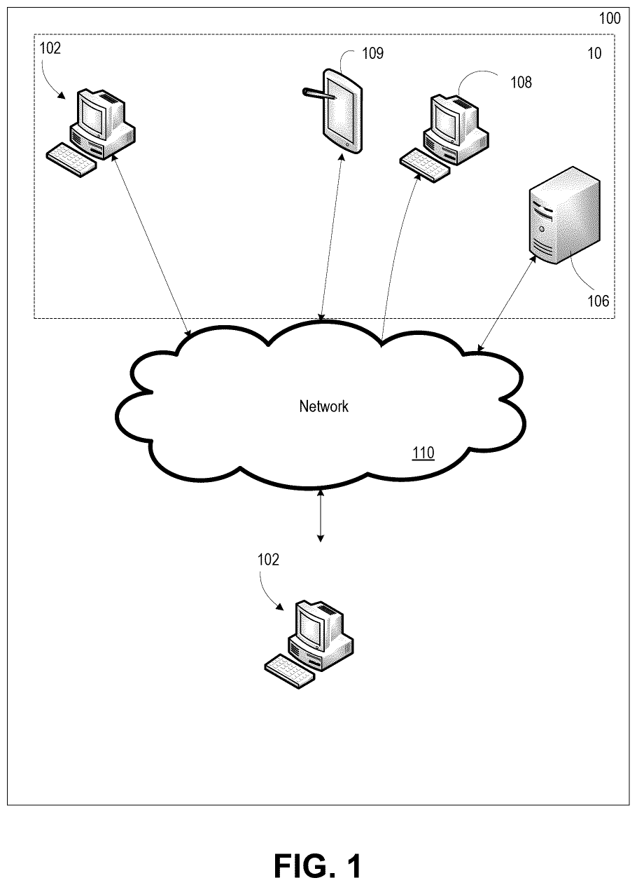

Various embodiments of the present invention make use of interconnected computer networks and/or components. FIG. 1 is a block diagram depicting components of an example computing system 100. Components of the computing system are interconnected to define a document processing and extraction system. As used herein, the term “document processing and extraction system” refers to a combination of hardware devices configured under control of software and interconnections between such devices and software.

As depicted, computing system 100 may include a variety of clients incorporating and/or incorporated into a variety of computing devices which may communicate with other computing devices 102 via one or more networks 110. For example, a client 102 may incorporate and/or be incorporated into client application implemented at least in part by one or more computing devices. Example computing devices may include, for example, at least one server 102 with a data storage 118 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1. In some embodiments, one or more computing devices may be logically internal to an organization 10 (depicted in FIG. 1 as devices 102, 109, 108 and 106 being internal to organization 10).

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the computing system 100 may provide access to one or more software applications. In some embodiments, components of systems such as a document processing and extraction system may be executed locally within organization 10, without requiring the extensive computing resources of external computing platforms (such as cloud services platforms). In still other embodiments, a document processing and extraction system may include sending and receiving information, requests and responses to third party services external to the organization 10 (such as, for example, large language models (LLMs) including generative pre-trained transformers (GPTs) maintained by third party platforms external to organization 10).

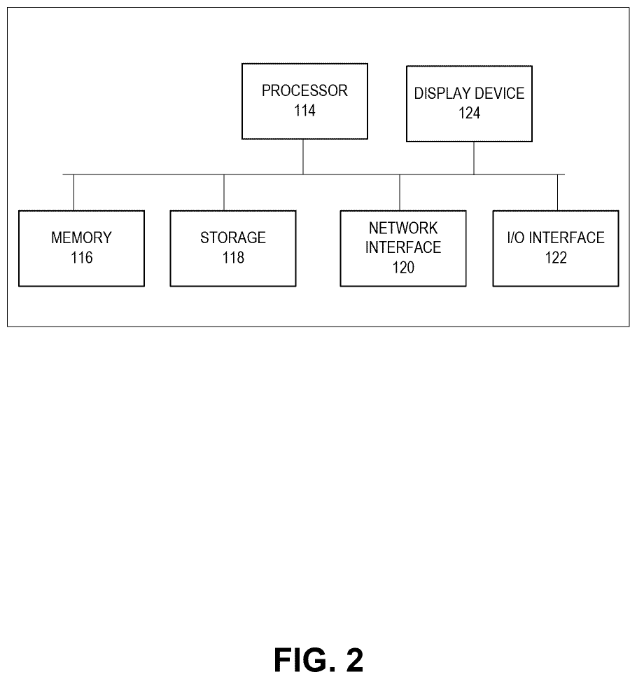

FIG. 2 is a block diagram depicting components of an example computing device, such as a desktop computing device 102, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the systems and methods described herein to processor 114 and/or to other computing devices. In some embodiments, I/O interface 122 may be compatible with protocols such as WiFi, Bluetooth, and other communication protocols.

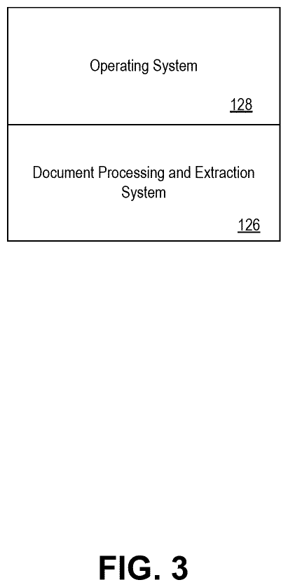

Software may be loaded onto one or more computing devices. Such software may be executed using processor 114. FIG. 3 depicts a simplified arrangement of software at an example computing device. The software may include an operating system 128 and application software, such as document processing and extraction system 126. It will be appreciated that in some computing environments, such as distributed computing environments, implementation, and administration of a service such as system 126 may be distributed amongst a plurality of separate computing devices within and/or external to an organization 10, and FIG. 3 is intended to depict a simplified logical separation between an operating system 128 and an application executing on one or more computing devices.

Some conventional document-image extraction techniques follow a two-stage pipeline in which, at the first stage, a document page image is converted into an intermediate representation (such as an intermediate layout data structure), and at the second stage, reasoning and extraction are performed.

Traditional OCR-based pipelines convert document images into an intermediate representation (plain text, in the case of OCR) and then perform downstream information extraction processing on the plain text. OCR engines such as Tesseract and commercial pipelines (e.g., ABBYY FineReader, Amazon Textract, and the like) focus primarily on textual transcription and discard a potentially significant portion of the spatial and visual layout information that encodes the structure of a page of a document. The discarding of spatial and visual layout information may have particularly severe negative effects for tabular elements of documents (e.g., tables, and other grid-like elements), where semantic relations are visually organized rather than linearly encoded. As a result, downstream information extraction techniques (e.g., rule-based methods, regular expression (regex) templates, or natural language processing (NLP) models) perform poorly in capturing row-column relationships, merged cells, and hierarchical table layouts. OCR noise and formatting inconsistencies may further propagate errors into entity extraction and key-value retrieval tasks.

Attention-based transformer architectures, such as vision language models (VLMs), have been used for document understanding and information extraction. Some common VLMs may include LayoutLM, LayoutLMv2, LayoutLMv3, and DocFormer, which are configured to encode text, spatial coordinates, and visual cues, which may yield improvements in tasks such as form understanding, key information extraction, and receipt parsing. Nevertheless, the performance of attention-based transformer models depends heavily on OCR-derived outputs (such as text tokens), which leads to a vulnerability to OCR noise, transcription errors, and domain shift problems that may be severe in certain contexts (e.g., visually dense documents containing irregular tables, nested headers, handwritten adjustments, such as financial documents).

Some general-purpose VLMs, such as LLaVA and vision-enabled GPT-4 o (also referred to as GPT-4o-Vision, or GPT-4o in short) may be configured to jointly interpret visual regions and embedded text. Some VLMs such as Donut and Pix2Struct may bypass the OCR process and instead directly generate structured text sequences based on an image of a page of a document. However, such VLMs nevertheless perform poorly with fine-grain document comprehension, and in particular when a task requires accurate integration of textual content and layout structure together, due to insufficient resolution and the incomplete capture of structural context.

Some systems such as Smoldocling, Nanonets-ocr, Azure AI Document Intelligence, Google Document AI, and Mistral OCR may be configured to generate structured document representations to facilitate a machine-readable layout construction. Structured prediction models may be used to convert page images of documents into symbolic markup language (e.g., Markdown, HTML, XML, and the like) that is machine-interpretable and may support downstream extraction or reasoning. However, structured prediction models are nevertheless susceptible to structural inconsistencies, row spanning errors, missing cell boundaries, faulty nested tables, and/or misaligned merged cells, particularly in the case of low-resolution scanned documents and/or irregular layouts commonly found in certain types of documents (e.g., financial documents).

Some embodiments of a document processing and extraction system as described herein may repair erroneous tabular layout representations, constrain reasoning to a corrected, auditable structured data object, and output strict schema-locked outputs, which may provide robustness and interpretability which has not previously been possible using existing techniques.

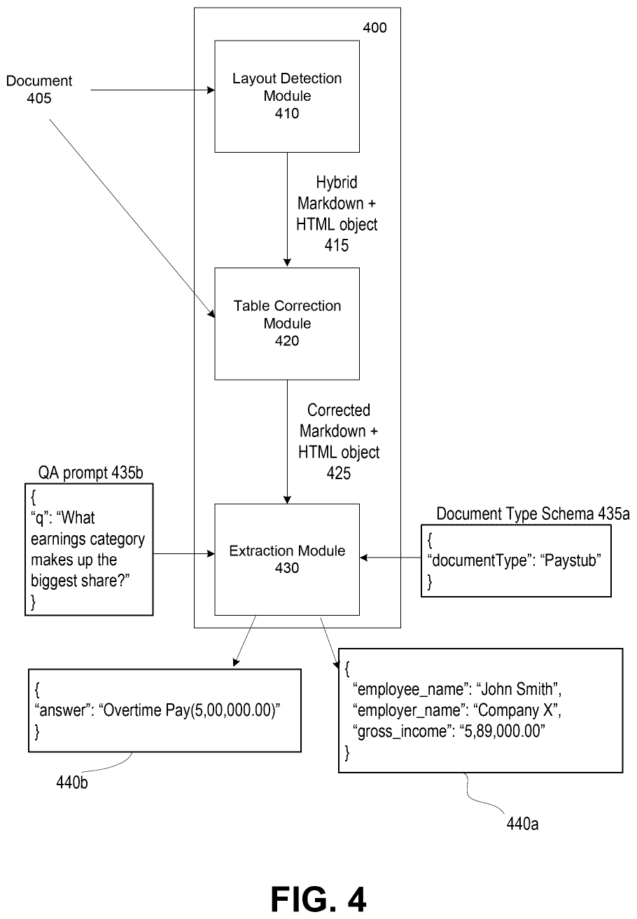

FIG. 4 depicts a logical system architecture diagram for an example document processing and extraction system 400, in accordance with some embodiments. As depicted, system 400 includes a layout detection module 410, a table correction module 420, and an extraction module 430. In some embodiments, layout detection module 410 is configured to receive an input document 405 and output an intermediate layout data structure 415.

In some embodiments, the intermediate layout data structure is a hybrid data object 415. In some embodiments, the hybrid data object comprises a first markup language to represent text and a second markup language to describe tabular regions. In some embodiments, the first markup language is Markdown language for describing text, and the second markup language is HTML to describe tabular regions. Document 405 and hybrid data object 415 are then used as inputs for table correction module 420, which is configured to identify and repair structural errors in the HTML component of the hybrid data object 415, and output a corrected hybrid data object 425. Extraction module 430 is configured to receive the corrected hybrid data object 425 and perform information extraction 435a and/or question answering 435b. In some embodiments, information extraction and/or question answering may be performed solely on corrected hybrid data object 425, without reference to the original document 405.

In some embodiments, table correction module 420 is configured to use a VLM to visually ground table structures within the original page of document 405 and repair layout errors in hybrid data object 415. In some embodiments, table correction module 420 is configured to perform these repairs without any retraining of the VLM and without multiple iterations in a feedback loop (a so-called “one-shot” system). In some embodiments, the resulting corrected hybrid data object 425 may provide a more accurate representation of the contents and layout of document 405, which may facilitate more accurate information extraction at extraction module 430.

In some embodiments, system 400 includes a layout detection module 410 that converts page images into an intermediate layout data structure, such as a hybrid Markdown-HTML representation 415. The table correction module 420 is configured to visually ground and repairs erroneous HTML tables in hybrid data object 415 using a VLM to generate a corrected hybrid data object 425. The information extraction module 430 is configured to perform schema-driven field extraction and/or document-level question answering using the corrected layout representation 425. Some embodiments of system 400 may be configured to run one or more of modules 410, 420 and 430 independently, which may allow for flexible integration. Moreover, in some embodiments, layout detection module 410 and/or table correction module 420 may be document-agnostic, providing further implementation flexibility in a variety of contexts.

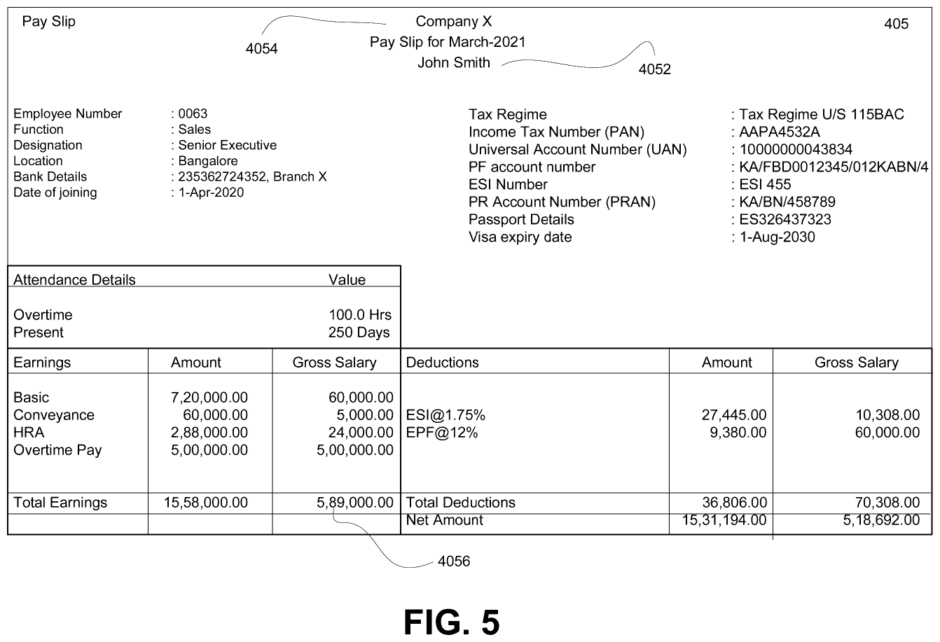

FIG. 5 depicts an example document 405 which may be ingested by system 400. As depicted, document 405 is a paystub which includes both textual data and tabular layout data. For example, textual data may include the employee name 4052, the employer name 4054, as well as various other biographical and regulatory information concerning the employee. Tabular layout data includes, for example, the tabular data relating to the employee's attendance, earnings, gross salary, and deductions.

In some embodiments, layout detection module 410 is configured to receive document 405 (e.g., a scanned document, an electric document, or the like) in the form of one or more page images and generate an intermediate layout data structure intended to preserve the original document structure. In some embodiments, a high-accuracy layout detection service (e.g., the Azure AI Document Intelligence “layout” model) may be used to detect and parse text and/or tables in the page image. Although this disclosure refers to the Azure AI Document Intelligence Layout model, it should be appreciate that this is merely an example and that many other layout detection services (open-source or closed-source) may be used in particular circumstances, as appropriate.

In some embodiments, layout detection module 410 is configured to serialize non-tabular regions of document 405 in a first markup language (e.g., Markdown format) for compactness and readability. Layout detection module 410 may be further configured to represent tabular regions of document 405 using a second markup language (e.g., HyperText Markup Language (HTML) elements). In some embodiments, HTML elements may include HTML <table> elements. In some embodiments, HTML table elements may include <thead>, <tbody>, <tr>, <th>, and <td>tags. The HTML elements may preserve rowspan and colspan attributes. As described herein, the combined Markdown-HTML intermediate layout data structure may be referred to as a hybrid data object 415. In some embodiments, the intermediate layout data structure may be serialized using one or more of hybrid Markdown-HTML, constrained JSON-LD, and/or XML-based code with explicit semantic roles and validation schemas.

The hybrid format may allow for complicated table layouts and structural information to be retained, which represents an improvement over plain-text OCR systems, which often fail to preserve structural information. Further, embedding HTML tables within the Markdown file results in a self-contained and deterministic format which is more conducive to accurate downstream processing.

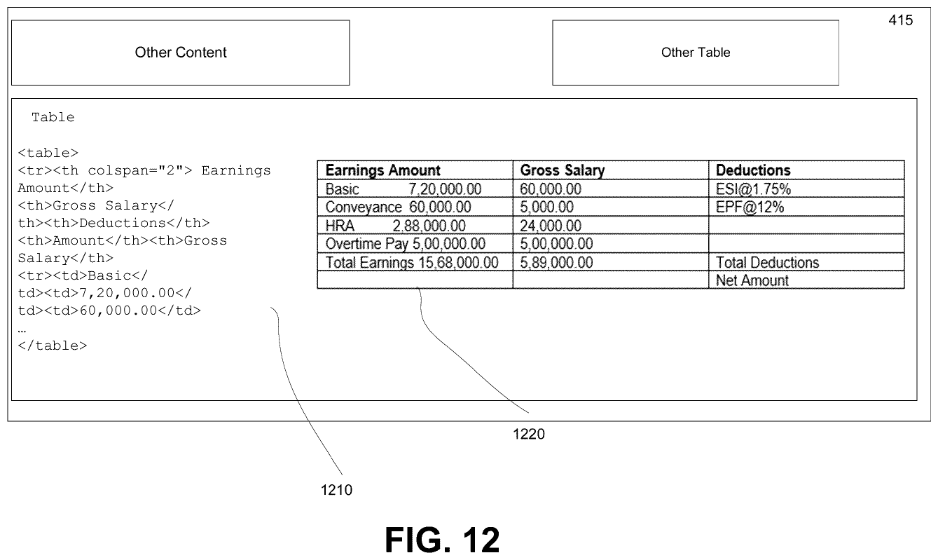

A common shortfall of conventional VLMs is the production of imperfect table layouts when applied to real-world cases. For example, HTML tables generated by VLMs may exhibit column drift, header misalignment, or spurious merges. FIG. 12 is an illustration of an example hybrid data object 415 generated based on the document 405 depicted in FIG. 5. As depicted, hybrid data object 415 includes Markdown language to describe textual data and HTML code 1210 to encode the tabular data in document 405. A rendering of the HTML code 1220 shows that the generated hybrid data object 415 includes an error relative to the original document 405, namely the ‘Earnings’ column and the ‘Amount’ column being erroneously merged into a single column with concatenated values.

System 400 further includes table correction module 420 which may ameliorate some or all of the above-noted challenges. In some embodiments, table correction module 420 is a multi-modal table-correction module which can process and correct textual data modalities and tabular data modalities. Table correction module 420 may be configured to receive an example of a previously created noisy hybrid data object 415 and the corresponding corrected hybrid data object 425 representing a correct version of the table, together with the document image 405 as contextual guidance, which may enable table correction module 420 to repair alignment errors in hybrid data object 415, thereby restoring layout fidelity.

In some embodiments, table correction module 420 is configured to perform a “one-shot” correction. That is, table correction module 420 may be configured to perform a single iteration of the VLM being prompted with an example noisy table and the corrected version of the noisy table, and being provided with the original page image of document 405 and prompted to repair any inaccuracies in hybrid data object 415 to produce corrected hybrid data object 425.

In still other embodiments, table correction module 420 may be configured to perform more than one iteration, rather than a one-shot approach. That is, after a first iteration, the generated corrected hybrid data object 425 may be fed back and used as an input for table correction module 420 together with the original page image of document 405 and prompted to repair any further detected inaccuracies. Of course, a multi-iteration approach would require more time and processing power to execute than a one-shot approach. In many scenarios, a one-shot approach may improve accuracy sufficiently to obviate the need for the additional time and computing resource costs of further iterations.

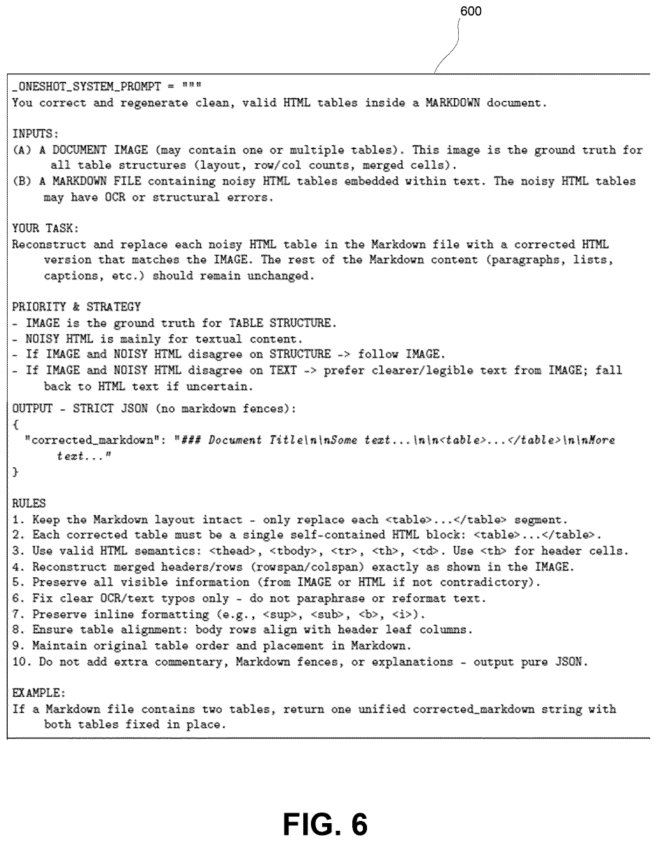

In some embodiments, table correction module 420 is configured to receive a prompt for a VLM (e.g., GPT-4o, or the like). An example prompt is depicted in FIG. 6. In some embodiments, a prompt may include one or more of (i) an instruction describing the table-correction task (e.g., an instruction to align the HTML table structure with the visual appearance of the table in the page image 405 while preserving all cell content), (ii) a single in-context example consisting of a noisy hybrid Markdown-HTML table (e.g., a previous hybrid data object 415 generated by layout detection module 410 based on a previous document) paired with its corresponding corrected hybrid Markdown-HTML version (e.g., a corrected hybrid data object 425) for contextual learning, and (iii) the target document 405 page image together with the hybrid Markdown-HTML data object 415 produced by layout detection module 410 for that page image.

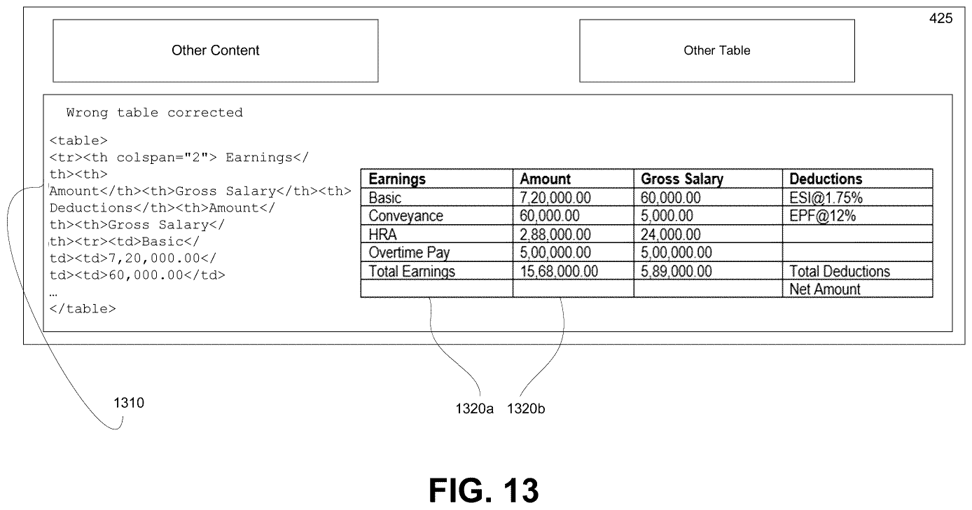

FIG. 13 depicts an example corrected hybrid data object 425 generated by table correction module 420, based on the document 405 depicted in FIG. 5 and the noisy hybrid data object 415 depicted in FIG. 12. As can be seen, the corrected hybrid data object 425 has been modified to include additional HTML code (the addition of “</th><th>” between the words ‘Earnings’ and ‘Amount’) which separates the Earnings column 1320a and the Amount column 1320b.

In some embodiments, the VLM of table correction module 420 may use the visually-grounded information from the document page image and/or the structural hints from the noisy HTML in hybrid data object 415 to output the corrected Markdown-HTML data object 425. In some embodiments, the VLM of table correction module 420 may be configured to run at a low temperature (e.g., between 0 to 0.8) to encourage deterministic outputs and reduce variability. Table correction module 420 may resolve header misalignments, restore proper column boundaries, and/or correct rowspan and colspan attributes, even in cases in which the initial Markdown-HTML data object 415 is produced by an OCR model which lacks layout awareness. In addition, because corrections are expressed as a textual transformation to the Markdown-HTML data object, intermediate results can be inspected and audited, which may be important in certain contexts (e.g., for financial documents).

Returning to FIG. 4, the third phase of document processing and extraction system 400 is extraction module 430. In some embodiments, extraction module 430 comprises a large language model (LLM) such as GPT-4 which is configured to receive the corrected hybrid data object 425 from table correction module 420 for information extraction and/or question answering. In some embodiments, extraction module 430 is configured to receive a schema corresponding to a particular document type. Extraction module 430 may be configured to output a record (e.g., a strict JSON object) which contains key-value fields which are described in the document-type schema received by extraction module 430. For example, a document-type schema may be a paystub schema, and may include a defined set of fields for a paystub, such as gross pay, net pay, withholding tax, and deduction categories. FIG. 4 depicts an example document type schema 435a for a paystub, which includes key fields for “employee_name” 4052, “employer_name” 4054, and “gross_income” 4056. As depicted in FIG. 4, in response to receiving the paystub schema 435a, extraction module may output a record 440a which retrieves the key field values for each key field 4052, 4054, 4056 from the corrected hybrid data object 425.

In some embodiments, extraction module 430 may employ extraction prompts which cause the LLM used by extraction module 430 (e.g., an LLM such as GPT-4) to traverse the corrected hybrid data object 425, locate each required field from the document-type schema in context (e.g., by matching header names, row labels, and the like, in corrected tables), normalize units and number formats, and return a structured output (e.g., a JSON file 440a). The use of a structured output file 440a may be particularly advantageous, as structured data may then be incorporated into downstream processing for other purposes (e.g., automation in credit assessment, compliance workflows, and the like).

In some embodiments, the question answering (“QA”) functionality of extraction module 430 may comprise receiving a QA-related prompt 435b. In some embodiments, the QA 435b prompt may be worded so as to emphasize concise, evidence-grounded answers. In some embodiments, queries in the QA prompt 435b may target global properties (e.g., total amounts) and/or relational patterns within tables (e.g., “which deduction is the highest?”). In some embodiments, the corrected hybrid data object 425 may be used to answer free-form, natural language questions about the content of document 405 content, such as “Which earnings category is largest?”, “What is the total amount of deductions?”, or “How did the net pay change compared to the previous period?”. The dual-mode capabilities of extraction module 430 may be a consequence of the corrected hybrid data object 425 providing a single, unified structured representation of document 405.

An example QA prompt 435b is depicted in FIG. 4, which asks “What earnings category makes up the biggest share?” of the paystub document 405. Extraction module 430 may traverse the corrected hybrid data object and formulate a deterministic answer 440b (which correctly states that the “overtime pay” earnings category makes up the biggest share of earnings, with a value of “5,00,000.00”).

In some embodiments, the Azure Document Intelligence layout model may be used by layout detection module 410 to generate of the initial hybrid data object 415 (e.g., containing a Markdown-HTML representation of document 405). In some embodiments, the GPT-4o model may be used by table correction module 420 and/or extraction module 430 for table correction and subsequent extraction or QA, respectively. In some embodiments, a set of carefully engineered prompts may be fed into the modules 410, 420, 430 that encode task-specific instructions and in-context examples.

By way of example, some embodiments of document processing and extraction system 400 may operate as follows. A paystub image 405 (as depicted, for example, in FIG. 5) may be ingested and transmitted to layout detection module 410. Layout detection module 410 may generate a hybrid Markdown-HTML data object 415 which captures the text regions and tables layout of the paystub image.

The table correction module 420 then processes the hybrid Markdown-HTML object 415 along with the corresponding page image from document 405, invoking GPT-4o with a one-shot correction prompt 600 to generate a corrected hybrid Markdown-HTML file 425.

The extraction module 430 may then call GPT-4o together with a document-type schema, and using a schema-aware prompt 435a (e.g., for paystub field extraction). In some embodiments, extraction module 430 may call GPT-4o using a QA prompt 435b (e.g., for Finance-QA-style reasoning). In both information extraction mode and QA mode, extraction module 430 may use only the corrected hybrid Markdown-HTML file 425 as context. The resulting output (e.g., JSON records for information extraction tasks, and concise answers for QA tasks) may be stored in a database, used to trigger downstream activities, and/or returned to the user.

In some embodiments, the table-correction module may be provided with a concise, layout-aware prompt including: (i) an instruction describing the system's role and table correction task; (ii) a one-shot example comprising a noisy Markdown-HTML object 415 and a corresponding corrected Markdown-HTML object 425 pair for in-context learning; and (iii) the target image with its raw Markdown-HTML representation from the layout detection model. The table-correction module may be optimized through prompt-engineering to identify the most effective prompt design. An example one-shot prompt 600 is depicted in FIG. 6.

Various embodiments have been evaluated empirically using three datasets. The evaluation tested 1) paystub extraction tasks; 2) document-level question-answering (QA) tasks; and 3) table correction tasks. A sample of the Paystub dataset use in the evaluation is depicted in FIG. 5.

Paystub Dataset: The paystub empirical extraction evaluation utilized a total of 53 scanned paystub images containing 159 annotated key-value pairs. Among these scanned paystubs, 10 were anonymized samples, and 43 were randomly selected from publicly available personal finance datasets. Each scanned paystub document was annotated for three key fields: employer_name 4504, employee_name 4502, and gross_income 4056.

FinanceQA Dataset: For the empirical document-level question answering (QA) task, an embodiment of system 400 was evaluated on a subset of 154 financial document images with 992 question-answer pairs derived from a larger original dataset. Given the original dataset's large scale (over 100,000 samples) and the dataset's high diversity in document layouts and content types, a Contrastive Language-Image Pre-training (CLIP)-based clustering strategy was used to obtain a representative subset. Specifically, visual embeddings were extracted using CLIP and K-means clustering (K=50) was applied to group documents by visual similarity. From each cluster, sampled representative instances were selected to ensure balanced coverage across layout types. Additionally, because the original dataset contained a substantial amount of annotation noise, the QA pairs in the subset were reviewed and corrected to improve label quality and fairness in evaluation. The samples utlimately tested covered a wide range of query types, from factual lookups (e.g., “What is the due date?”) to relational reasoning (e.g., “Which deduction category is largest?”), thereby providing a comprehensive assessment of extraction module 430's capability for reasoning over financial documents.

Table Correction Dataset: The table correction task was evaluated using 300 complex tables from the PubTabNet test split dataset. These image-HTML pairs were selected to include challenging layout structures, such as nested headers and merged cells.

All of the above-noted datasets were subdivided into a development set (10%) and a held-out test set (90%). The development set was used only for prompt iteration and refinement. After selecting the final prompt, a single evaluation was performed using the held-out test set, which was not used during prompt engineering.

Embodiments were benchmarked against single-stage and multi-stage alternatives, so as to isolate the contribution of each component. The testing alternatives also used as a baseline included:
(1) Direct VLM Baseline (Single-Stage): A pure visual baseline using GPT-4o-vision directly performing document Visual Question Answering (VQA) and field extraction from the image without any intermediate layout modeling.
(2) Two-Stage Baseline (Plain Text+Extraction): A two-stage configuration where the first stage performs OCR-only text extraction using the Azure AI Document Intelligence “read” model (“Azure Read”), followed by a second stage using GPT-4o for extraction and/or document QA.
(3) Enhanced Two-Stage Pipelines (Different Layout Models): Further variants were tested using different layout detection backends (both open-source and closed-source), including the Azure AI Document Intelligence “layout” model (“Azure Layout”), Nanonets OCR, and Mistral OCR to generate Markdown representations. Azure Layout and Nanonets OCR produce hybrid Markdown-HTML data objects, and Mistral produces plain Markdown data objects. Each of these variants used the same extraction and document QA model (GPT-4o) to ensure a consistent comparison across different layout encoders.
(4) Multi-Stage Pipelines (With and Without Table Correction): For each two-stage pipeline, the effect of integrating a tablecorrection module 420 was evaluated.

Additionally, a prompt-level comparison was conducted for the table-correction task to quantify the degree to which different prompting strategies influence layout repair performance, using the uncorrected layout model output as the baseline.

Performance of the disclosed system was measured against the baseline using (1) field-level extraction accuracy for the data element extraction task, (2) answer accuracy for the document-level QA task, and (3) Tree-Edit-Distance-based Similarity (TEDS) for the table correction task. TEDS measures tables' HTML similarity by counting the minimal tree-edit operations required to match generated artifact and ground truth. Two variants of TEDS were used for the evaluation: structure-only TEDS (setting structure_only=True), which measures the correctness of the table layout independent of cell content, and structure+text TEDS (setting structure_only=False), which jointly evaluates both structure and textual accuracy. These complementary metrics together capture robustness, reasoning precision, and layout complexity across the entire pipeline.

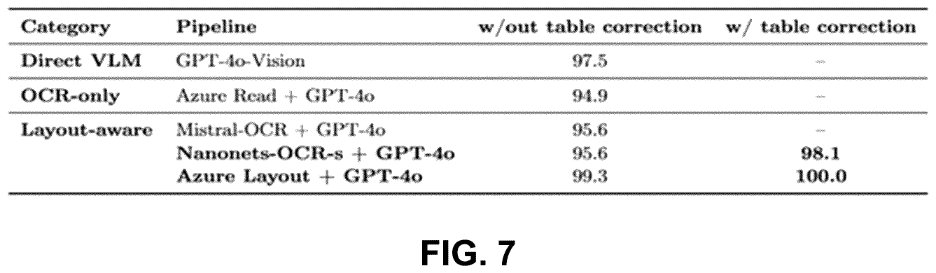

FIG. 7 is a table summarizing the paystub data extraction test accuracy across different pipelines for the Paystub Dataset. As can be seen, configurations which included a table correction module 420 yielded greater accuracy than configurations without a table correction module. Direct VQA using GPT-4o-Vision achieved 97.5% accuracy, while naive OCR pipelines (i.e., Azure Read) achieved around 95% accuracy, limited by lack of contextual awareness of the layout of the document. The Azure Layout model, which produces layout-aware hybrid Markdown-HTML representations had 99.3% accuracy, indicating that layout information greatly assists large language models in contextual reasoning. Finally, the configuration incorporating a one-shot multimodal table correction module 420 achieved 100% accuracy. The results in FIG. 7 confirm that layout detection and multimodal table correction contribute cumulatively to the accuracy of document-level extraction.

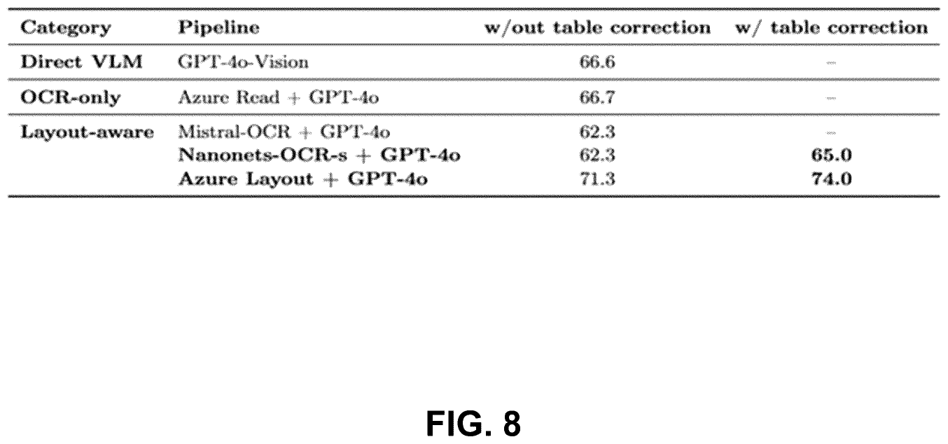

According to the second evaluation, various embodiments were evaluated for answering free-form questions grounded in document content and layout. FIG. 8 summarizes the results of document-level question answering (QA) using the above-described FinanceQA Dataset. As depicted, vision-only and plain-OCR pipelines scored around 66%, constrained by erroneously segmented table regions and ambiguous numeric associations. The Azure Layout model achieved accuracy of 71.3%. Embodiments including a table correction module 420 obtained improved scores relative to those without, and reached 74.0% with the Azure Layout model with table correction, confirming that fine-grain layout repair amy benefit not only schema-based extraction, but also general reasoning and comprehension required in question answering.

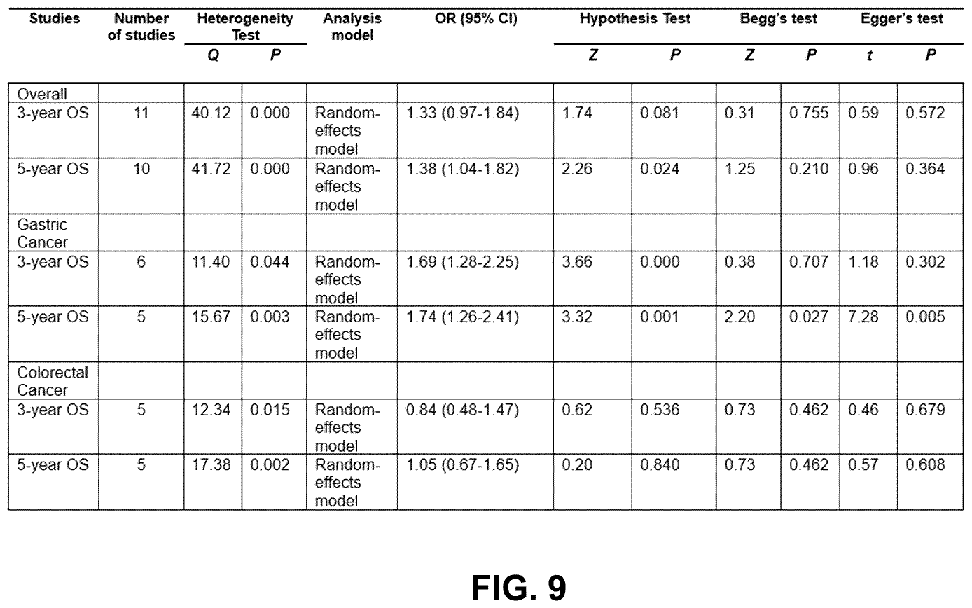

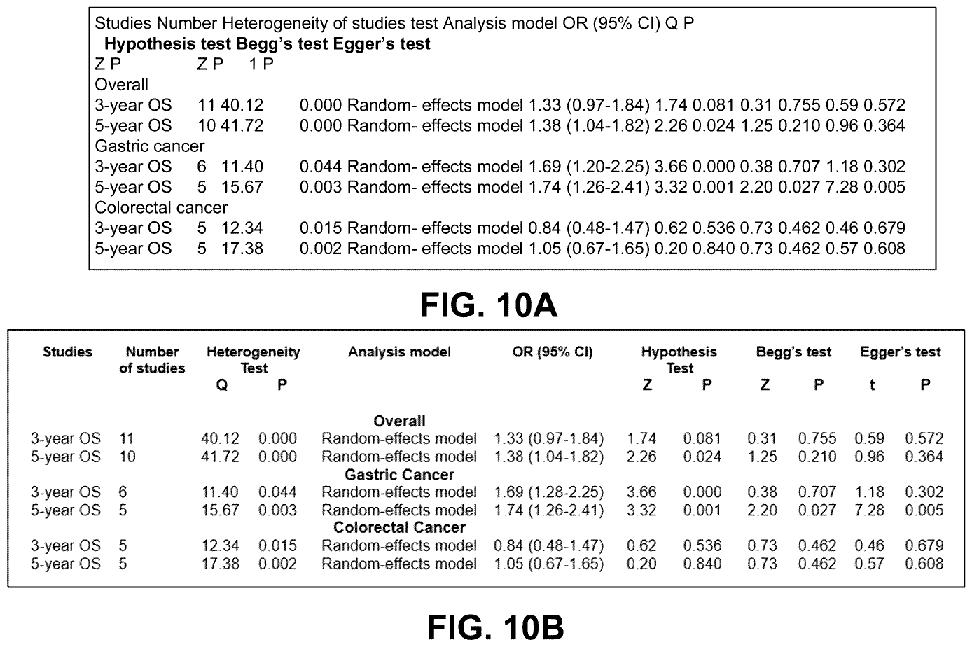

In the third evaluation, the table correction module 430 performance was evaluated against a baseline. To isolate and quantify the contribution of the table correction module 430, several correction strategies were evaluated on the Table Correction Dataset. FIG. 9 is an illustration of an example document 900 containing tabular data. FIG. 10A is an illustration of a noisy HTML representation of the document of FIG. 9 generated by Azure Layout alone, which contains layout inconsistencies. For example, relative to the original document 900, the integrity of the subheadings below each of the hypothesis test, Begg's test, and Egger's test headings has been lost, and original boldface columns do not appear to share any coherent connection with the data in the body of the table. FIG. 10B depicts a rendering based on a corrected hybrid data object after being processed by table correction module 420, which rectifies most of the layout inconsistencies.

Four configurations were evaluated empirically: no correction, text-only correction, multi-modal correction, and embodiments of system 400 using a one-shot multi-modal table correction approach. The text-only correction configuration fed only the noisy Markdown-HTML to the VLM model, without providing the table image. The multimodal correction configuration allowed the VLM model to jointly process the table image and the noisy HTML, enabling repairing repair row-column alignment, reconstructing header hierarchies, and recovering missing cell spans.

A wide range of prompting strategies were considered and evaluated in the development set of the datasets. Prompts that explicitly defined the task and described common layout errors, as well as prompts that incorporated few-shot examples were tested. A two-step formulation was tested in whichj the table correction module 420 first identified layout errors and then applied targeted fixes. Different reasoning styles were examined, including directly editing the noisy Markdown-HTML using the image as guidance, and alternatively regenerating a clean Markdown-HTML representation from the image while using the noisy HTML only as a weak reference. The empirically best-performing strategy was then selected on the held-out test set of the dataset. An example prompt in accordance with some embodiments is depicted in FIG. 5 for reference.

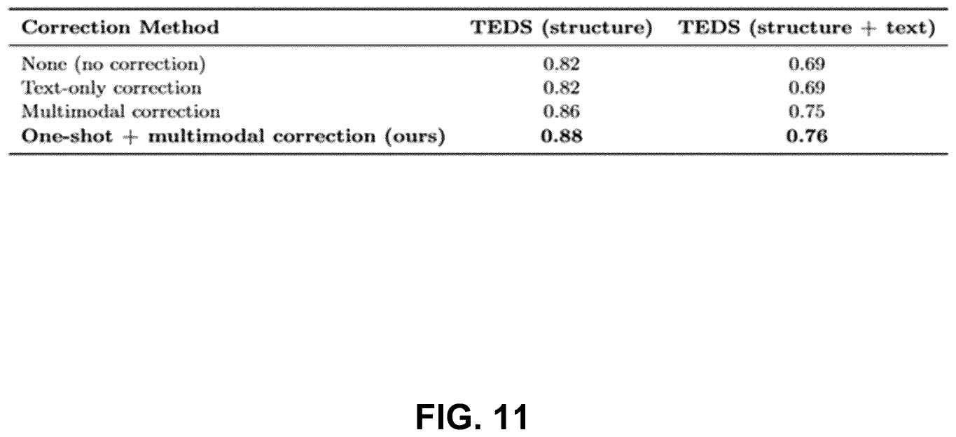

As shown in FIG. 11, the one-shot multimodal table correction approach improved the TEDS score (structure) from 0.82 to 0.88, and improved the TEDS score (structure+text) from 0.69 to 0.76. These improvements did not require any retraining, and all improvement gains arose entirely from in-context prompting with a single example.

The results across the evaluations of information extraction, QA, and table-correction tasks collectively demonstrate that some embodiments described herein may offer advantages over traditional OCR pipelines and direct end-to-end VLM reasoning.

In some embodiments, one-shot multimodal table correction may provide consistent, cross-task advantages. By jointly using the page image as structural ground truth and the noisy HTML as textual guidance, the table correction module may fix alignment drift, restore header hierarchies, and produce cleaner HTML tables, with or without any model fine-tuning. These improvements may propagate across downstream tasks such as paystub extraction, and Finance-QA tasks Notably, the gains in accuracy were found to persist when the input markup came from a different layout model (e.g., Nanonets OCR), thereby illustrating that the table correction module may be model-agnostic and robust.

In some embodiments, hybrid Markdown-HTML representations may outperform plain-text OCR outputs. Across both the Paystub and FinanceQA benchmarks, layout-aware inputs consistently enabled stronger grounding compared to plain OCR pipelines. The preservation of reading order, row-column relationships, and explicit table boundaries may allow GPT-4o to perform extraction and reasoning over a cleaner structural artifact rather than raw pixels or linearized text, thereby demonstrating that accurate intermediate layouts may be a key determinant of downstream accuracy.

Some embodiments described herein may outperform monolithic end-to-end VLM reasoning. Although GPT-4o-Vision provides strong single-stage baselines, GPT-4o-Vision remains less reliable for tasks requiring fine-grain layout understanding or numeric associations. By decoupling layout detection, table correction, and reasoning, some embodiments describd herein may enable each module 410, 420, 430 to specialize and reduce the cognitive burden on the LLM. This may lead to higher accuracy, better interpretability, and simpler debugging than direct VLM interpretation of raw images.

Explicit layout and multimodal correction may form a powerful foundation for financial document understanding. Moreover, modular, training-free designs may make some embodiments described herein practical for enterprise deployment, as components can be upgraded independently while retaining system stability.

Because some embodiments described herein might not require any model retraining, some embodiments may offer rapid deployment and low integration costs for enterprise environments with strict change-control and auditability requirements. Commercial applications of some embodiments may include automated income verification from paystubs for credit adjudication, tax statement parsing for compliance workflows, document verification for mortgage processing, extraction of line-item details from invoices for accounts payable automation, healthcare explanation of benefits (EOB) and medical billing normalization, utilities/telecommunications statement processing and reconciliation, and high-precision data extraction for risk assessment and financial analytics.

Some embodiments further support document-level question answering, enabling financial analysts, auditors, and compliance teams to query documents without manual inspection, thus reducing processing time and human error. Because some embodiments are model-agnostic, they may be integrated into existing enterprise workflow engines, document-management systems, RPA platforms, and case-processing tools with minimal modification.

Although described predominantly in terms of financial documents, it should be appreciated that some embodiments described herein may be expanded to handle other document types. For example, the prompt library may be expanded for edge-case table formats, optimizing the multimodal table correction process for batch processing, and integrating lightweight validation checks to automatically flag low-confidence corrections.

In some embodiments, to reduce inference cost and latency in high-volume settings, some embodiments can be configured with smaller or distilled open-source VLMs that run efficiently on-premise, which may reduce both cost and dependence on proprietary services.

In some embodiments, to reduce prompt sensitivity and improve performance with unusual layouts or heavy OCR noise, automated prompt-optimization strategies and iterative self-refinement loops can be used to detect and repair structural inconsistencies more robustly, thereby reducing reliance on manual prompt tuning.

In some embodiments, when multi-page tables or cross-page references are being processed, cross-page entity linking and multi-page table reconstruction can be used to extend the system to longer length documents (e.g., as tax returns, financial filings, or the like).

In some embodiments, open-weight layout models and lightweight multimodal LLMs may increase transparency, portability, and applicability in regulated environments, while improving reproducibility and on-premise deployment.

Some embodiments may be model-agnostic in terms of compatibility with multiple VLMs, multimodal or text-based engines, and selection of the models can be based on enterprise constraints.

The modular structure of some embodiments may provide flexibility by permitting increased control over model weights, batch correction calls, and structural templates. Similarly, because some embodiments may operate on structured artifacts/data objects rather than raw images, some embodiments may support easier auditability and downstream logging, which may improve trust and compliance in regulated settings.

According to still another aspect, there is provided a computer-implemented method for reliable information extraction from financial documents, comprising: generating, from a noisy layout artifact of a page of a document, a canonical artifact that encodes narrative content in reading order and tabular content with hierarchical headers and explicit row and column spans; performing an image-conditioned table correction that jointly consumes the page image and the canonical artifact to repair header alignment, column boundaries, and row and column spans while preserving non-tabular content; and performing schema-driven extraction on the corrected canonical artifact to produce strict JSON conforming to a predefined document-type schema and answering document-level queries using only the corrected canonical artifact as context.

According to still another aspect, there is provided a computer-implemented system comprising one or more processors and one or more memories storing instructions that, when executed at the one or more processors, cause the system to: construct a canonical artifact from a noisy layout artifact of a document page, the canonical artifact preserving reading order for narrative content and encoding tables with hierarchical headers and explicit row and column spans; execute a single-pass, image-conditioned table correction, without fine-tuning, that jointly consumes the document page image and the canonical artifact to repair table layout while preserving non-tabular content; and map the corrected canonical artifact to a predefined schema to emit strict JSON and to provide answers to document-level queries based solely on the corrected canonical artifact.

According to still another aspect, there is provided a non-transitory computer-readable medium storing instructions that, when executed by one or more processors, cause a computing device to: produce a canonical artifact from a noisy layout artifact of a document page, the canonical artifact encoding narrative content in reading order and tables with hierarchical headers and explicit row and column spans; perform a single-pass, image-conditioned correction of the canonical artifact using the document page image, without fine-tuning, to repair header alignment, column boundaries, and row and column spans while preserving non-tabular elements; and perform schema-driven extraction on the corrected canonical artifact to generate JSON according to a predefined schema.

In some embodiments, the canonical artifact may be serialized using one or more of hybrid Markdown-HTML, constrained JavaScript Object Notation for Linked Data (JSON-LD), and XML-based code with explicit semantic roles and validation schemas.

In some embodiments, the image-conditioned table correction is performed in a single pass and without fine-tuning.

Some embodiments further comprise applying validator checks including at least one of arithmetic reconciliation, header-value consistency, unit normalization, referential integrity, or range or format checks.

Some embodiments further comprise when a validation threshold is not met, initiating re-correction or arbitration.

In some embodiments, source references to the page image may include page coordinations and/or bounding polygons that identify regions corresponding to extracted content and/or corrected table cells.

Some embodiments further comprise generating audit provenance data structure including at least one of layout differences between the noisy and corrected canonical artifacts, cell-level confidence labels, source references to page coordinates, and cryptographic hashes or signatures binding artifacts to model or configuration parameters

In some embodiments, performing schema-driven extraction comprises normalizing locale-specific formats including currency symbols, decimal separators, and/or date formats.

Some embodiments further comprise clustering similar tables and reusing exemplars or prompts to reduce latency and cost, and selecting among multiple correction outputs based on validator scoring.

Some embodiments further comprise computing cross-document drift detection and change attribution using canonical artifacts and validator outcomes.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

1. A computer-implemented method for converting a document to an extraction-compliant data structure, the method comprising:
receiving an image of a page of a document;
generating, by a layout detection module, an intermediate layout data structure that encodes text content and tabular layout information;
repairing, by a table correction module, one or more errors in said intermediate layout data structure based on said image of said page as a visual reference; and
generating a corrected intermediate layout data structure representative of contents of said page of said document based on said repairing.

2. The method of claim 1, wherein said intermediate layout data structure is a hybrid data object wherein the text content of said page is encoded using a first markup language, and the tabular layout information is encoded using a second markup language.

3. The method of claim 2, wherein the first markup language is Markdown, and the second markup language is HyperText Markup Language (HTML).

4. The method of claim 1, wherein said repairing the intermediate layout data structure comprises:
receiving, at said table correction module, a training pair comprising a previous intermediate layout data structure and a corrected intermediate layout data structure based on said previous intermediate layout data structure,
wherein said repairing is based on said image of said page, said intermediate layout data structure, and said training pair.

5. The method of claim 2, wherein said repairing comprises modifying said HTML code.

6. The method of claim 5, wherein said repairing comprises preserving said Markdown code.

7. The method of claim 1, wherein said table correction module comprises a vision language model, and wherein a temperature parameter of said vision language model is between 0 and 0.8.

8. The method of claim 1, wherein said repairing comprises at least one of:
(i) detecting misaligned, missing, or erroneously merged cells;
(ii) splitting, merging, and/or re-indexing cell nodes to correct the tabular topology, (iii) inserting missing header nodes and/or updating header-to-cell edges; and/or (iv) updating span attributes and region borders to reflect corrected geometry.

9. The method of claim 4, wherein said repairing comprises receiving, at said table correction module, a prompt comprising an instruction describing a table correction task.

10. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The method of claim 4, further comprising:
feeding back said corrected intermediate layout data structure to said table correction module; and
performing a second iteration of said repairing based on said image of said page and said corrected intermediate layout data structure.

22. The method of claim 4, wherein said repairing said intermediate layout data structure comprises a single iteration of said repairing based on said image of said page and said intermediate layout data structure.

23. A system for converting a document to an extraction-compliant data structure, the system comprising:
a computer-readable medium having stored thereon computer-executable instructions that, when executed by one or more processors, cause the one or more processors to perform a method comprising:
receiving an image of a page of a document;
generating, by a layout detection module, an intermediate layout data structure that encodes text content and tabular layout information;
repairing, by a table correction module, one or more errors in said intermediate layout data structure based on said image of said page as a visual reference; and
generating a corrected intermediate layout data structure representative of contents of said page of said document based on said repairing.

24. The system of claim 23, wherein said intermediate layout data structure is a hybrid data object wherein the text content of said page is encoded using a first markup language, and the tabular layout information is encoded using a second markup language.

25. The system of claim 24, wherein the first markup language is Markdown, and the second markup language is HyperText Markup Language (HTML).

26. The system of claim 23, wherein said repairing the intermediate layout data structure comprises:
receiving, at said table correction module, a training pair comprising a previous intermediate layout data structure and a corrected intermediate layout data structure based on said previous intermediate layout data structure, and
wherein said repairing is based on said image of said page, said intermediate layout data structure, and said training pair.

27. The method of claim 24, wherein said repairing comprises modifying said HTML code.

28. The method of claim 27, wherein said repairing comprises preserving said Markdown code.

29. The method of claim 23, wherein said table correction module comprises a vision language model (VLM), and wherein a temperature parameter of said vision language model is between 0 and 0.8.

30. The method of claim 23, wherein said repairing comprises at least one of:
(i) detecting misaligned, missing, or erroneously merged cells;
(ii) splitting, merging, and/or re-indexing cell nodes to correct the tabular topology, (iii) inserting missing header nodes and/or updating header-to-cell edges; and/or (iv) updating span attributes and region borders to reflect corrected geometry.

31. The method of claim 26, wherein said repairing comprises receiving, at said table correction module, a prompt comprising an instruction describing a table correction task.

32. A computer-readable medium having stored thereon computer-executable instructions that, when executed by one or more processors, cause the one or more processors to perform a method of converting a document to an extraction-compliant data structure, the method comprising:
receiving an image of a page of a document;
generating, by a layout detection module, an intermediate layout data structure that encodes text content and tabular layout information;
repairing, by a table correction module, one or more errors in said intermediate layout data structure based on said image of said page as a visual reference; and
generating, a corrected intermediate layout data structure representative of contents of said page of said document based on said repairing.
